(19) United States
(12) Patent Application Publication
(10) Pub. No.: US 2009/0213567 A1
(43) Pub. Date: Aug. 27, 2009

(54) LIGHTED POWER OUTLET SYSTEM AND METHOD

(75) Inventors: Denny Mandapat, Chula Vista, CA (US); Sural Yegin, Chula Vista, CA (US); Carlos Ramirez, Chula Vista, CA (US)

Correspondence Address: Davis Wright Tremaine LLP/Leviton, 1201 Third Avenue, Suite 2200, Seattle, WA, 98101, US

(73) Assignee: LEVITON MANUFACTURING CO., INC., Little Neck, NY (US)

(21) Appl. No.: 12/035,801

(22) Filed: Feb. 22, 2008

(51) Int. Cl. F21V 33/00

(52) U.S. Cl. 362/95; 362/555

(57) ABSTRACT

A lighted power outlet system having a plurality of outlets includes light emitters, such as light emitting diodes or other light emitting devices. The light emitters are internally positioned within the interior of the outlet system so that light is projected through terminal apertures of the outlets. The projected light is visible from locations exterior to the outlet system to assist in guiding alignment of plug prongs with the terminal apertures for engagement of electrical plugs with the outlets of the outlet system.

### BACKGROUND OF THE INVENTION

1. Field of the Invention

The present invention is directed generally to electrical power outlets.

2. Description of the Related Art

Electrical power outlets, such as found in electrical power strips, are fashioned to receive plugs that terminate electrical cords or other electrical transmission media to furnish electrical power to equipment or other devices. Engagement of the plugs with the power outlets requires spatial alignment of plug prongs with terminal apertures of the outlets and then subsequent insertion of the plug prongs therein. Such engagement procedures can be problematic in dimly lit areas and/or areas that have other challenging visual acuity issues.

### BRIEF DESCRIPTION OF THE SEVERAL VIEWS OF THE DRAWING(S)

FIG. 1 is a front perspective view of a lighted power outlet system according to the present invention.

FIG. 2 is a schematic diagram of the outlet system of FIG. 1.

FIG. 2A is a schematic diagram of a particular version of the outlet system of FIG. 2 showing one implementation of the power components.

FIG. 3 is an enlarged partial front perspective view of the outlet system of FIG. 1 in a lit condition.

FIG. 4 is a back perspective view of the outlet system of FIG. 1.

FIG. 5 is a front perspective view of the outlet system of FIG. 1 with exterior housing removed.

FIG. 6 is a front top view of the outlet system of FIG. 1 with exterior housing removed.

FIG. 7 is a back perspective view of the outlet system of FIG. 1 with exterior housing removed.

### DETAILED DESCRIPTION OF THE INVENTION

A lighted power outlet system and method is present herein to include light emitters, such as light emitting diodes or other light emitting devices. The light emitters are internally positioned within the interior of the outlet system so that light is projected through the terminal apertures of the outlets. The projected light is visible from locations exterior to the outlet system to assist in guiding alignment of plug prongs with terminal apertures for engagement of electrical plugs with outlets of the outlet system.

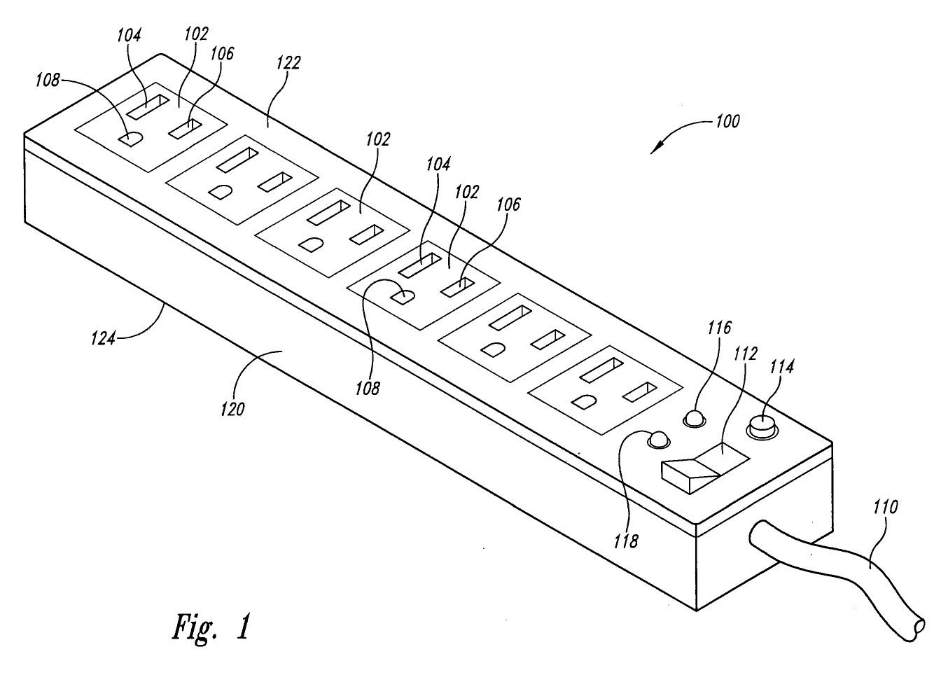

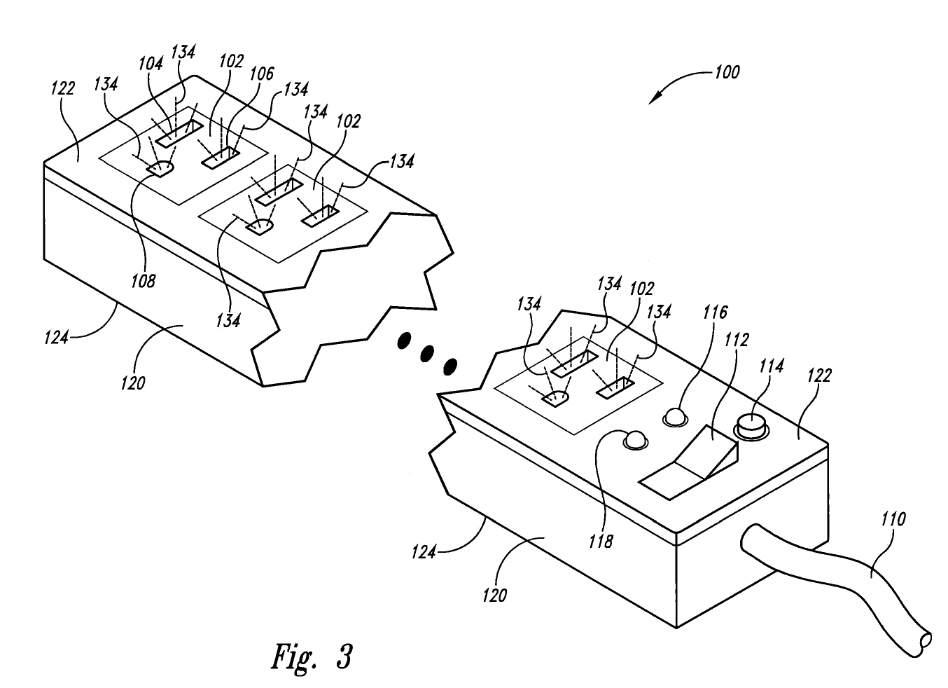

A light power outlet system 100 is depicted in FIG. 1 as including a plurality of outlets 102 each having a neutral terminal aperture 104, a positive terminal aperture 106, and a ground terminal aperture 108. The outlet system 100 receives electrical power from a supply cable 110 to be distributed through the outlets 102 to devices (not shown) that are coupled thereto. In the depicted implementation, the outlet system 100 has a power switch 112 with on and off positions (shown in the off position in FIG. 1). When the power switch 112 is in the off position no electrical power is available to the outlets 102 so that devices coupled to the outlets are not furnished electrical power by the outlet system 100. When the power switch 112 is in the on position (shown in FIG. 3 and discussed further below) electrical power is available to the outlets 102 so that devices coupled to the outlets are furnished electrical power by the outlet system 100.

In the depicted implementation, the outlet system 100 further includes a reset and/or fuse 114, a surge protection indicator 116, and a polarity and/or ground indicator 118 all of which can be optional accessories with other implementations. The outlet system 100 further includes a housing 120 to provide protection and/or aesthetic functionality for internal components housed therein. For illustration purposes, the outlet system is depicted as having a front side 122 and a backside 124.

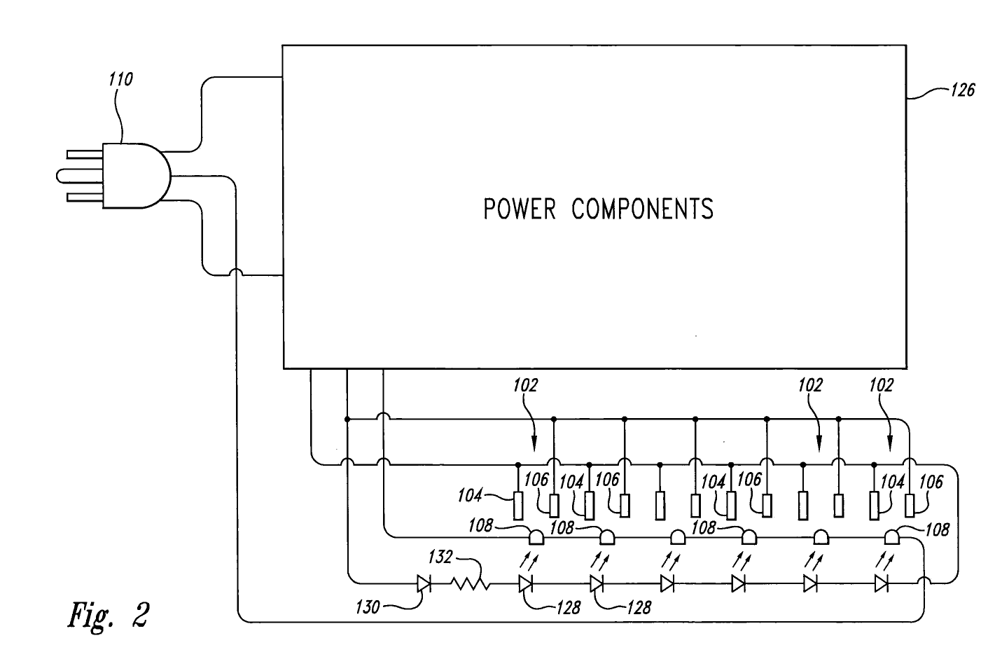

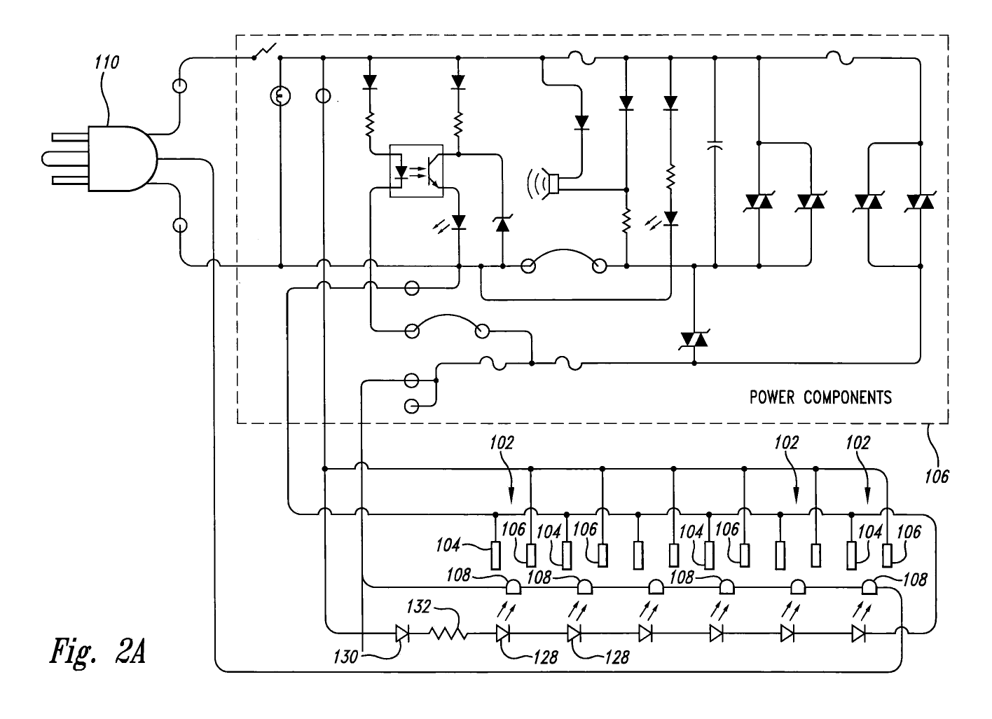

Components, both external and internal, of the outlet system 100, are represented schematically in FIG. 2 to include the supply cable 110 (shown with its plug), the plurality of outlets 102, power components 126, a plurality of light emitters 128, a regulating diode 130, and a regulating resistor 132. The power components 126 are provided for power conditioning and are otherwise involved with supplying electrical power to the outlets 102 as received through the supply cable 110. A particular implementation for the power components 126 is shown in FIG. 2A and other implementations can also be used. The light emitters 128 are shown in a one to one association with outlets 102 such that a different one of the light emitters is paired with a different one of the outlets.

In other implementations, other associations can be used such as one of the light emitters being associated with more than one of the outlets (one to many association), or more than one of the light emitters being associated with one of the outlets (many to one association), or other combinations thereof. Although the light emitters 128 are schematically depicted as being light emitting diodes, in other implementations, other devices that emit light can be used. The regulating diode 130 and regulating resistor 132 are provided to adjust electrical conditions to match requirements of the light emitters 128.

As shown in FIG. 3, when the power switch 112 is in the on position, the light emitters 128, positioned inside the interior of the housing 120 are energized to emit light. A portion of the emitted light is allowed to escape from the interior of the housing 120 through the neutral aperture 104, the positive aperture 106, and the ground aperture 108 of each of the outlets 102 to attract the attention of a sighted observer positioned in the vicinity of outlet system 100. By allowing a portion of the emitter light to shine through the apertures, the apertures are more clearly visible to an observer to assist the observer in guiding the prongs of a plug for engagement with one of the outlets 102.

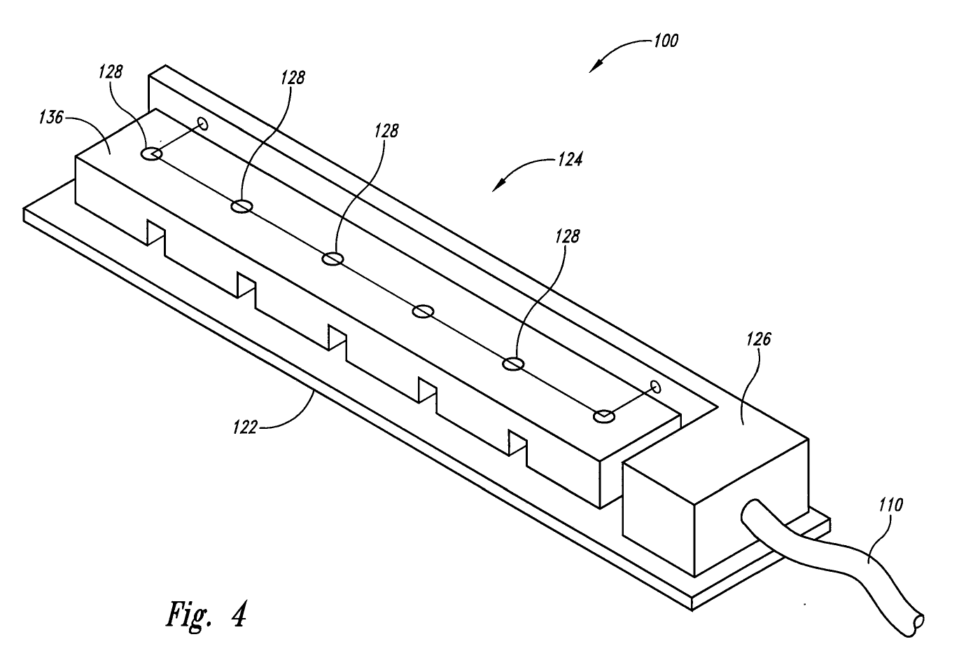

As shown in FIG. 4, a terminal carrier section 136 is generally located on the backside of the outlet system 100 to among other things physically support and retain the light emitters 128 in predetermined positions advantageous to directing at least a portion of light emitted therefrom to the respective one of the outlets 102 for each of the light emitters. In some implementations, the terminal carrier section 136 can be removably attached to a portion of the housing and to the remainder of the outlet system 100 to allow for ready access to the interior of the housing 120 for servicing of the power components 126 and/or the light emitters 128.

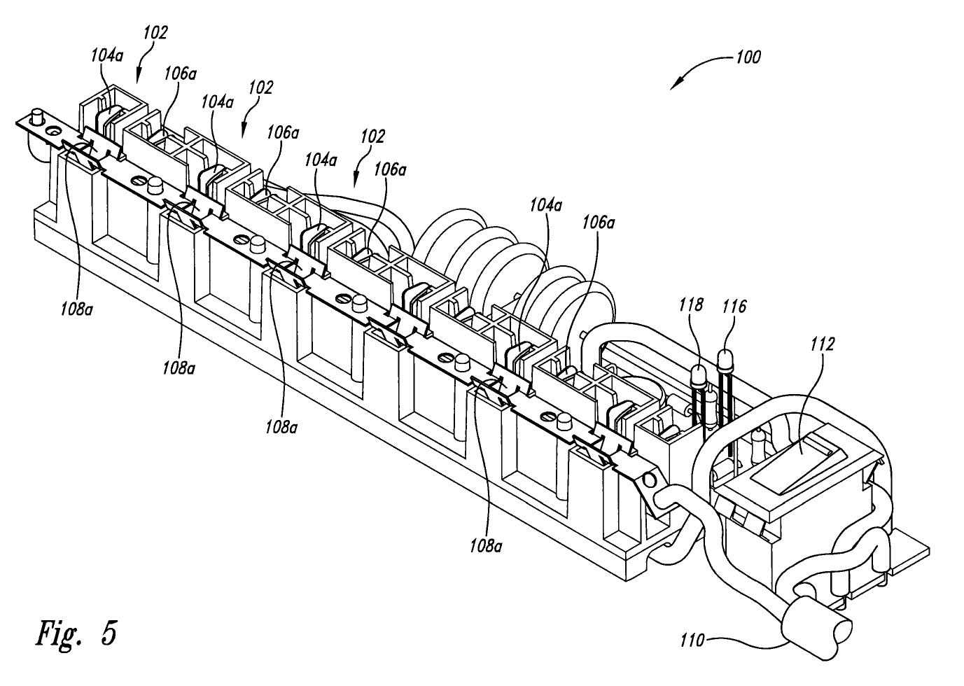

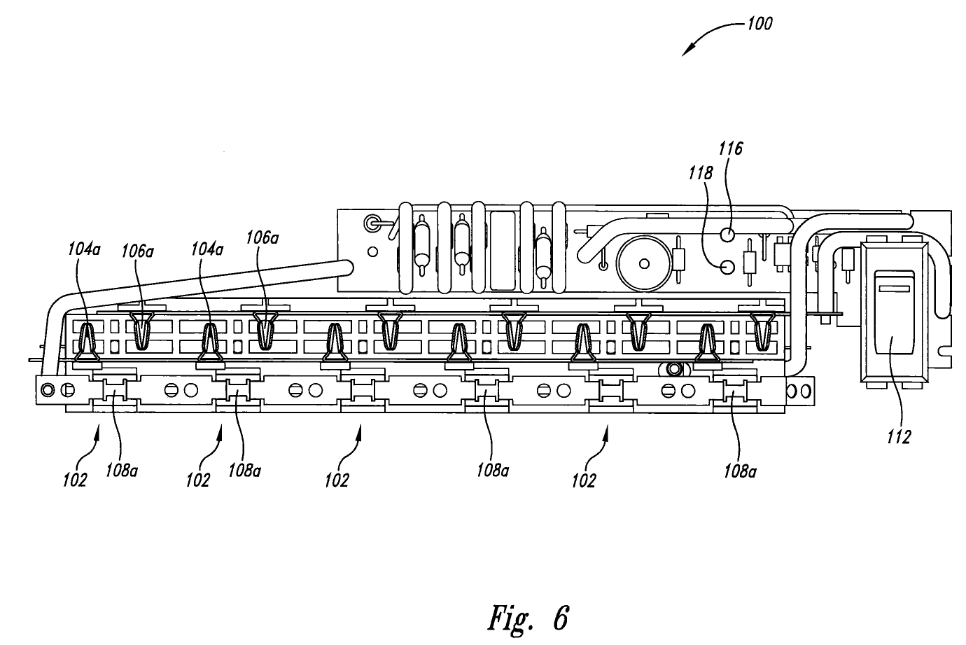

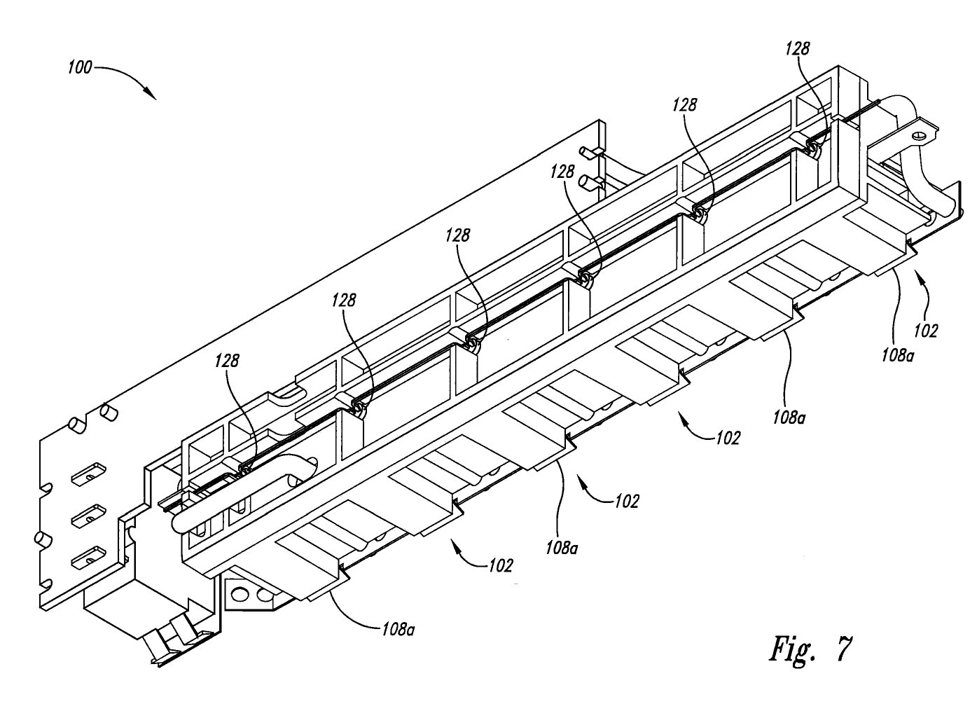

FIGS. 5-7 include views of the interior of the outlet system 100 with the housing 120 having been removed. Each of the outlets 102 includes a neutral terminal 104a (aligned and associated with the neutral aperture 104 to receive the neutral prong of a plug), a positive terminal 106a (aligned and associated with the positive aperture 104 to receive the positive prong of a plug), and a ground terminal 108a (aligned and associated with the ground aperture 104 to receive the ground prong of a plug) with a different one of the light emitters 128 positioned therebetween (as better shown in FIG. 6).

By such positioning, a single one of the light emitters 128 is able to project emitted light through the neutral aperture 104, the positive aperture 106 and the ground aperture 108 of an associated one of the outlets 102 thereby reducing the number of light emitters that might otherwise be needed for a desired level of exterior illumination through the apertures of the outlet. As mentioned above, other implementations may have other numbers of the light emitters 128 associated with numbers of the outlets 102 with consequential varying of positioning of the light emitters with respect to the neutral terminal 104a, the positive terminal 106a, and the ground terminal 108a of one or more of the outlets.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system comprising:
a housing having an interior and an exterior;
a plurality of outlets coupled with the housing, each outlet having a plurality of apertures for receiving electrical plug prongs; and
a plurality of light emitters positioned in the interior of the housing to, when energized, emit light through at least one of the plurality apertures of each of the outlets from the interior of the housing to the exterior of the housing, the light to be visible from the exterior of the housing.

2. The system of claim 1 wherein the light emitters are light emitting diodes.

3. The system of claim 1 wherein each outlet has an associated neutral terminal, a positive terminal, and a ground terminal, and a different one of the light emitters is positioned therebetween.

4. The system of claim 1 wherein each of the light emitters is positioned to emit light through the apertures of a different one of the outlets.

5. The system of claim 1 further including a power switch electrically coupled with the light emitters to control energizing of the light emitters and of the outlets, the power switch having an on position and an off position.

6. The system of claim 5 wherein when the power switch is in the off position, electrical power is prevented from energizing the light emitters and is prevented from being made available to the outlets.

7. The system of claim 1 further including power components configured to condition electrical power prior to being supplied to the outlets.

8. The system of claim 1 wherein the outlets and the light emitters are in a one to one association.

9. The system of claim 1 wherein the outlets and the light emitters are in a many to one association.

10. The system of claim 1 wherein the outlets and the light emitters are in a one to many associations.

11. The system of claim 1 further including a carrier section removably attached to a portion of the housing and wherein the light emitters are coupled to the terminal carrier section.

12. A system comprising:
a housing having an interior and an exterior;
an outlet coupled with the housing, the outlet having an aperture for receiving a prong of an electrical plug;
a light emitter positioned in the interior of the housing to emit light through the aperture from the interior of the housing to the exterior of the housing.

13. The system of claim 12 wherein the light emitter is a light emitting diode.

14. The system of claim 12 wherein the outlet has an associated neutral terminal, a positive terminal, and a ground terminal, and the light emitter is positioned therebetween.

15. The system of claim 12 further including a power switch electrically coupled with the light emitter to control energizing of the light emitter and of the outlet, the power switch having an on position and an off position.

16. The system of claim 15 wherein when the power switch is in the off position, electrical power is prevented from energizing the light emitter and is prevented from being made available to the outlet.

17. The system of claim 12 further including power components configured to condition electrical power prior to being supplied to the outlet.

18. The system of claim 12 wherein the outlet and the light emitter are in a one to one association.

19. The system of claim 12 further including a carrier section removably attached to a portion of the housing and wherein the light emitter is coupled to the terminal carrier section.

20. A method comprising:
providing a housing having an interior and an exterior;
coupling a plurality of outlets with the housing, each outlet having a plurality of apertures for receiving electrical plug prongs; and
positioning a plurality of light emitters in the interior of the housing to, when energized, emit light through at least one of the plurality apertures of each of the outlets from the interior of the housing to the exterior of the housing, the light to be visible from the exterior of the housing.

21. The method of claim 20 wherein the light emitters are light emitting diodes.

22. The method of claim 20 wherein each outlet has an associated neutral terminal, a positive terminal, and a ground terminal, and a different one of the light emitters is positioned therebetween.

23. The method of claim 20 wherein each of the light emitters is positioned to emit light through the apertures of a different one of the outlets.

24. The method of claim 20 further including providing a power switch electrically coupled with the light emitters to control energizing of the light emitters and of the outlets, the power switch having an on position and an off position.

25. The method of claim 24 further including when the power switch is in the off position, preventing electrical power from energizing the light emitters and preventing electrical power from being made available to the outlets.

26. The method of claim 20 further including providing power components configured to condition electrical power prior to being supplied to the outlets.

27. The method of claim 20 wherein the outlets and the light emitters are provided in a one to one association.

28. The method of claim 20 wherein the outlets and the light emitters are provided in a many to one association.

29. The method of claim 20 wherein the outlets and the light emitters are provided in a one to many associations.

30. The method of claim 20 further including providing a carrier section removably attached to a portion of the housing and coupling the light emitters to the terminal carrier section.
